(19) United States
(12) Patent Application Publication
(10) Pub. No.: US 2005/0220326 A1
(43) Pub. Date: Oct. 6, 2005

(54) Mobile identification system and method

(75) Inventor: Michael L. Sim, Reston, VA (US)

Correspondence Address: SCHIFF HARDIN, LLP;PATENT DEPARTMENT, 6600 SEARS TOWER, CHICAGO, IL, 60606-6473, US

(73) Assignee: RF Intelligent Systems, Inc.

(21) Appl. No.: 11/098,897

(22) Filed: Apr. 5, 2005

Related U.S. Application Data
(60) Provisional application No. 60/559,805, filed on Apr. 6, 2004.

(51) Int. Cl. G06K 9/00

(52) U.S. Cl. 382/118

(57) ABSTRACT

A method and apparatus for authenticating an identification of a person provides that biometric information is obtained from the person and a portion thereof is extracted and stored on a data carrier adapted for being carried by the person. A remaining portion of the biometric information is stored on an identification system. For authentication, the person presents the data carrier and new biometric information is obtained from the person. A comparison is made between the new biometric information from the person, the portion of the biometric information stored on the data carrier and the remaining portion of the biometric information stored in the identification system.

### CROSS-REFERENCE TO RELATED APPLICATION

The present application claims the benefit of U.S. Provisional patent application Ser. No. 60/559,805, filed Apr. 6, 2004, which is incorporated herein by reference.

### BACKGROUND OF THE INVENTION

1. Field of the Invention

The present invention relates generally to a system and method for identifying persons, and in particular to an identification system and method using biometric information of a person.

2. Description of the Related Art

Biometrics is the science of automatically identifying individuals based on their unique physiological and behavioral characteristics. Biometric information based on unique characteristics of a person's face, iris, voice, fingerprint, signature or DNA. These techniques can all be used to authenticate a person's identity from information stored in a database that is held on a token in two dimensional barcode, magnetic stripe, smart card, USB (Universal Serial Bus) device, memory stick or RFID (Radio Frequency Identification) format device.

The use of facial recognition has advantages over and above those of other biometrics, particularly in that the process is non-intrusive. Until recently this process was limited to the person being in front of a camera. The advent of 3D (three dimensional) facial capture and handheld wireless technology now allows the migration of the recognition process to difficult poses and to remote or difficult environments.

Identification systems are disclosed in International Patent Application publications WO 00/62474 published Oct. 19, 2000, and WO 02/09024 A1 published on Jan. 31, 2002. In WO 00/62474, a computer uses a facial biometric template to encode a document. In WO 02/09024 A1, a facial identification matrix is obtained. 2D and 3D biometric templates are created from a single camera and the facial index data is extracted. These published applications are incorporated herein by reference.

### SUMMARY OF THE INVENTION

The present invention provides a method and system whereby identification of a person is carried out using biometric data obtained from the person. An extraction of a portion of that biometric data is performed and the extracted information is stored on a portable data carrier. The remaining portion of the biometric data is stored on an identification system.

When an identification is to be performed, the person presents the data carrier and a comparison is made between new biometric information obtained from the person, the portion of the biometric information on the data carrier and the portion of the information on the identification system. All three components must correspond for an authentication of the identification.

### BRIEF DESCRIPTION OF THE DRAWINGS

FIG. 1 is a functional block diagram of an identification system according to the principles of the present invention, illustrating an enrollment process; and

FIG. 2 is functional block diagram of the identification system, illustrating the authentication process.

### DETAILED DESCRIPTION OF THE PREFERRED EMBODIMENTS

The present invention provides a system and method whereby an identification template has two parts, a token, card or other physical object (also referred to as a data carrier) provided with extracted biometric template information in computer readable form and residual biometric template information stored on a server or other identification system.

The authentication can only take place when the three elements of the system come together. They are: a) the person, b) the extracted template information, and c) the residual template information from the server.

Using the present method and system an identification process is carried out that provides that:
a) Ownership and control of the biometric information remains with the cardholder (also referred to as the data carrier holder).
b) The divided biometric template information process prevents any possibility of identity theft.
c) Any attempt to copy the ID (Identification) card or other data carrier will result in a copy that can only be used by the original owner and is therefore not usable by any other person.
d) Manufacture of ID cards or other data carriers from an illegal system will result in the manufactured cards failing to authenticate a new individual due to the requirement for identification that a portion of the biometric data is held on the server or other identification system and is an intrinsic part of the validation process.

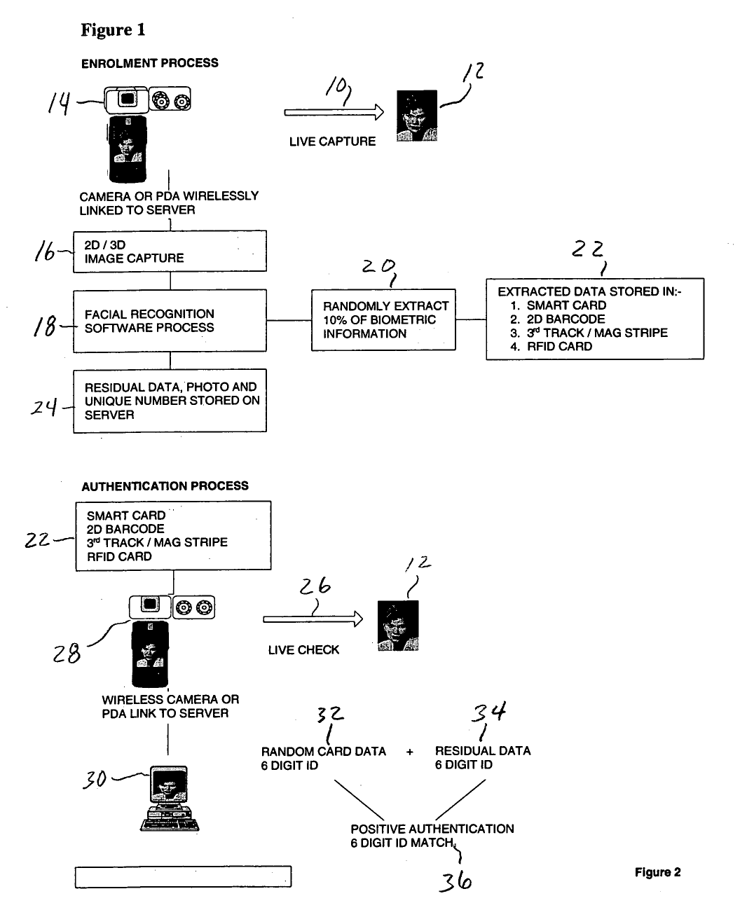

As shown in FIG. 1, an extraction process is provided for extracting the biometric information. This is also referred to as an enrollment process. The enrollment process begins with a live capture 10 of an image of a person 12 using a camera or other photographic device 14. In one embodiment, the photographic device 14 is a PDA (personal data assistant) having a built-in camera. In a preferred embodiment, the photographic device 14 is wirelessly linked to a server or network. The image is processed using 2D/3D (two dimensional/three dimensional) capture software 16 and a facial recognition process is performed at 18. A random extraction of 10 percent of the biometric information is performed at 20. Other percentages are of course possible in other embodiments. The extracted data is stored, at 22, in an item that the user, in other words, the person 12, may carry or otherwise have with them when identification is needed. These can include but are not limited to, a smart card, a 2D (two dimensional) barcode, a 3D (three dimensional) track, a magnetic stripe (such as is found on a credit card or identification card), a radio frequency readable card (such as an RFID card), or the like. These and comparable technologies are referred to here as data carriers. The residual data (the remaining 90 percent of the biometric data) is stored on a server 24. The server 24 may be a computer system, computer network, the Internet, an intranet, LAN, WAN, or other such device and is referred to here as an identification system. This residual data is accompanied by a unique number associated with the data and by the photo, in one embodiment.

The process is described for facial recognition using photographic data as the input for the biometric data. The same data extraction and identification process can be applied to a number of biometric technologies including: fingerprint recognition, iris recognition, voice recognition, and signature recognition, and the like.

Authentication according to the present method and apparatus is shown in FIG. 2. The authentication can only take place when the three elements of the system come together. They are: a) the person, b) the extracted biometric template information, and c) the residual template information from the server. In the identity verification process, the extracted data 22 on the data carrier is presented by the person 12. A live check 26 is performed by a camera or other photographic device 28. The information from these two sources (the person and the partial data on the data carrier) is provided to an identification system 30. A comparison is performed of the data from the data carrier 32 and the residual data 34 on the identification system. These are compared to biometric data from the person 12 and if a match is found, then a positive identification 36 of the person is made. In one embodiment, the match is made to an accuracy of a six digit identification number.

Thus, in the method authentication of an identification, an individual's facial biometric template information is produced and stored in a manner which will prevent identity theft. In one embodiment, a random extraction of 10% of the total identification template information is obtained, which is then stored on a card and given to the individual. The residual template information is stored on a secure server. An authentication occurs when the individual, the card information and the residual information comes together.

This reduces the possibility of an individual utilizing similar biometric hardware and software technology to create a fake machine-readable ID. Individuals attempting to copy or manufacture a card with this biometric information will fail as the stored 90% of template information will not correspond with the newly extracted 10% of data.

The present method and apparatus can be used for authentication of travel documents (visas/boarding passes), in banking, healthcare, social security, immigration, education, prisons, law enforcement, secure access, ATM, document security, voting, retail and the like.

Images of the person are obtained using various image capture devices, such as a web cam, CCTV (Closed Circuit Television), 2D camera, 3D camera or the RIS 2D/3D handheld biometric computer. The facial image is processed by the 2D/3D face recognition software resident on the handheld computer and/or server to the point where biometric template information has been extracted and is ready for storage or comparison. At this point a software process is applied to the template which:
a) Extracts approximately 10% of the total template data by a random separation process. This in principle can be described as similar to a PKI type process.
b) Generates a multiple digit number which is attached to the extracted template and similarly to the remaining template information.
c) The extracted template information is then stored on the person's ID card in 2D barcode, magnetic stripe, chip, RFID or USB token or a memory stick format.
d) The residual template information is stored on a secure server.

The person's ID card or token is generated and given of the person to hold, maintaining at all times “ownership and control” by the cardholder. The two divided parts of the template have no individual value and cannot be used in isolation.

This invention is related to inventions described in co-pending provisional patent applications 60/559,804 filed Apr. 6, 2004, Ser. No. 60/559,883 filed Apr. 6, 2004 and Ser. No. 60/559,933 filed Apr. 6, 2004, and in the non-provisional applications claiming the benefit of these provisional applications. Each of these applications is incorporated herein by reference.

Thus, there is described and shown a method and apparatus for authenticating an identification of a person provides that biometric information is obtained from the person and a portion thereof is extracted and stored on a data carrier adapted for being carried by the person. A remaining portion of the biometric information is stored on an identification system. For authentication, the person presents the data carrier and new biometric information is obtained from the person. A comparison is made between the new biometric information from the person, the portion of the biometric information stored on the data carrier and the remaining portion of the biometric information stored in the identification system.

Although other modifications and changes may be suggested by those skilled in the art, it is the intention of the inventors to embody within the patent warranted hereon all changes and modifications as reasonably and properly come within the scope of their contribution to the art.

1. A method of producing, storing and using an individual's facial biometric template information, comprising the steps of:
extracting identification information including the sub-steps of:
obtaining biometric information from a person;
extracting a portion of the biometric information;
storing the portion on a data carrier adapted to be under control of the person;
storing remaining portions of the biometric information on an identification system;
authenticating the identification information including the sub-steps of:
receiving the data carrier from the person;
obtaining new biometric identification information from the person;
comparing at least two of the portion of the biometric information and the remaining portions of the biometric information and the new biometric information to one another to authenticate an identity of the person.

2. A method as claimed in claim 1, wherein said portion of the biometric information extracted for storage on the data carrier is about ten percent of the biometric information.

3. A method as claimed in claim 1, wherein said step of storing the remaining portions of the biometric information includes storing the biometric information on a secure server.

4. A method as claimed in claim 1, wherein said data carrier includes a card to be given to the person.

5. A method as claimed in claim 1, further comprising the step of:
refusing authentication of the identification upon the new biometric information from the person failing to correspond to at least one of the biometric information stored on the identification system and the biometric information on the data carrier.

6. A system for authenticating an identification, comprising an apparatus constructed to perform the following method steps:
extracting identification information including the sub-steps of:
obtaining biometric information from a person;
extracting a portion of the biometric information;
storing the portion on a data carrier adapted to be under control of the person;
storing remaining portions of the biometric information on an identification system;
authenticating the identification information including the substeps of:
receiving the data carrier from the person;
obtaining new biometric identification information from the person;
comparing at least two of the portion of the biometric information and the remaining portions of the biometric information and the new biometric information to one another to authenticate an identity of the person.
